(19) United States
(12) Patent Application Publication
(10) Pub. No.: US 2026/0153174 A1
(43) Pub. Date: Jun. 4, 2026

(54) QUICK CONNECTOR FOR ULTRA-LOW TEMPERATURE VACUUM PIPES

(71) Applicant: ATOZ Co., Ltd., Hwaseong-si (KR)

(72) Inventors: Haeyun PARK, Ansan-si (KR); Youngdon KIM, Seongnam-si (KR); Jonghwa LEE, Incheon (KR); Byungjin CHOI, Hwaseong-si (KR)

(73) Assignee: ATOZ Co., Ltd., Hwaseong-si (KR)

(21) Appl. No.: 19/313,873

(22) Filed: Aug. 29, 2025

(30) Foreign Application Priority Data
Dec. 3, 2024 (KR) 10-2024-0177151

(51) Int. Cl. F16L 37/02

(52) U.S. Cl. CPC F16L 37/02; F16L 2201/40

(57) ABSTRACT

Disclosed is a quick connector for ultra-low temperature vacuum pipes, the quick connector including a male connector having a connection pipe provided along a center line thereof, a female connector having a connection pipe provided along a center line thereof, the female connector being connected to the male connector, a pipe coupling means configured to couple the connection pipe of the male connector and the connection pipe of the female connector to each other, and a heat conduction path formation means provided in each of the male connector and the female connector, the heat conduction path formation means being configured to form a multilayer heat conduction path in a direction perpendicular to the connection pipe, a part of the heat conduction path formation means provided in the male connector and a part of the heat conduction path formation means provided in the female connector being in contact with each other.

### CROSS-REFERENCE TO RELATED APPLICATION

This application claims the benefit of Korean patent application no. 10-2024-0177151 filed on Dec. 3, 2024, in the Korean Intellectual Property Office, the entire disclosure of which is incorporated herein by reference for all purposes.

### BACKGROUND OF THE INVENTION

### Field of the Invention

The present invention relates to a quick connector for ultra-low temperature vacuum pipes, and more particularly to a quick connector for ultra-low temperature vacuum pipes capable of reliably preventing freezing and condensation at a connection portion of the quick coupler in a low-temperature contraction environment, securing a sufficient heat conduction path with a relatively reduced length of the connector, thereby enabling compactness of an apparatus to which the quick connector is applied, being used universally in various high-density apparatuses in which the quick connector is adopted, ensuring sealing performance regardless of the type of coolant, and achieving excellent insulation effects regardless of the vaporization rate of a medium used in the quick connector.

### Description of the Related Art

Quick connectors (also known as quick couplers) are well-known in the art to which the present invention pertains, and a quick connector generally includes a female portion designed to cooperate with an end of a pipe (a male end of a pipe).

The quick connector couples two pipes in a cooling circuit to each other to form a safe mating structure, whereby the two pipes are fixed by the connector to form a sealed joint.

The quick connector is widely used to connect gas lines, hydraulic pipes, and cooling circuit components to each other. The quick connector uses a so-called push fitting arrangement by which a user pushes a male portion (typically formed at an end of a pipe) into a female portion in the connector, wherein complete coupling is achieved when the male and female portions are fastened together.

The configuration of a conventional quick connector and problems thereof will be described with reference to FIG. 1. FIG. 1 is a view showing a conventional quick connector, wherein both a perspective view and a sectional view are provided to facilitate understanding of the configuration.

As shown in FIG. 1, the conventional quick connector has a long heat conduction path configured to prevent freezing and condensation at a connection portion. Therefore, the connector is very long, which limits the use thereof in environments requiring high integration.

In addition, the conventional quick connector has a structure where the sealing portion cannot be perfectly sealed, leading to separation of the sealing portion due to low-temperature contraction. Furthermore, perfect sealing is impossible in environments in which the fluid is under high pressure, and for these reasons, the coupling direction must be used in a vertical form.

In addition, the conventional quick connector is connected to a vacuum pipe, in which case the space between an outer cover (a casing) and the pipe through which a fluid flows is maintained under vacuum. However, freezing occurs due to short distance between the pipe through which the low-temperature fluid flows and an external pipe, and a direct heat conduction path is formed due to freezing, which leads to condensation outside.

Furthermore, if the conventional quick connector is directly welded to the pipe through which the low-temperature fluid flows in order to form a vacuum independently in the outer cover (the casing), the welded joint becomes a heat conduction path, causing freezing or condensation on the outer cover. In addition, there is no means configured to form a vacuum internally, whereby a port for vacuum formation must be disposed externally, resulting in poor manufacturability and economic efficiency.

In addition, the sealing portion of the conventional quick connector is loosened due to low-temperature contraction, allowing a fluid to leak out. The leaked fluid vaporizes, and pressure equalization (pressure balance) prevents further fluid leakage. However, this technology may not be used depending on the type of an internal fluid, such as coolant that does not vaporize easily, and also has the problem of reduced insulation effects due to convection in the connector.

### PRIOR ART DOCUMENTS

### Patent Documents

(Patent Document 1) Korean Registered Patent Publication No. 10-0929152 (Published on Dec. 1, 2009)
(Patent Document 2) Korean Registered Patent Publication No. 10-1378916 (Published on Mar. 28, 2014)
(Patent Document 3) Korean Patent Application Publication No. 10-2006-0059009 (Published on Jun. 1, 2006)
(Patent Document 4) Korean Utility Model Application Publication No. 20-2018-0003206 (Published on Nov. 13, 2018)

### SUMMARY OF THE INVENTION

The present invention has been made in view of the above problems, and it is an object of the present invention to provide a quick connector for ultra-low temperature vacuum pipes capable of reliably preventing freezing and condensation at a connection portion of the quick coupler in a low-temperature contraction environment, securing a sufficient heat conduction path with a relatively reduced length of the connector, thereby enabling compactness of an apparatus to which the quick connector is applied, and being used universally in various high-density apparatuses in which the quick connector is adopted.

It is another object of the present invention to provide a quick connector for ultra-low temperature vacuum pipes capable of ensuring sealing performance regardless of the type of coolant, and achieving excellent insulation effects regardless of the vaporization rate of a medium used in the quick connector.

The objects of the present invention are not limited to those mentioned above, and other unmentioned objects will be clearly understood by those skilled in the art based on the following description.

In accordance with the present invention, the above objects and other features can be accomplished by the provision of a quick connector for ultra-low temperature vacuum pipes, the quick connector including a male connector having a connection pipe provided along a center line thereof, a female connector having a connection pipe provided along a center line thereof, the female connector being connected to the male connector, a pipe coupling means configured to couple the connection pipe of the male connector and the connection pipe of the female connector to each other, and a heat conduction path formation means provided in each of the male connector and the female connector, the heat conduction path formation means being configured to form a multilayer heat conduction path in a direction perpendicular to the connection pipe, a part of the heat conduction path formation means provided in the male connector and a part of the heat conduction path formation means provided in the female connector being in contact with each other.

In the present invention, each of the male connector and female connector may include a casing, a coupling cover member provided at one end of the casing, and a fastening flange provided at the other end of the casing, and the coupling cover member may include a flange portion having one end coupled to the casing, a bellows portion having one end coupled to the other end of the flange portion, and a closing cap portion coupled to the other end of the bellows portion, the closing cap portion having a pipe through-hole formed in the center thereof, and the coupling cover member and the connection pipe may be vacuum brazed.

In the present invention, the pipe coupling means may include a first coupling member provided at the other end of the connection pipe of the male connector, a second coupling member provided at one end of the connection pipe of the female connector, a third coupling member coupled to the outside of an overlapping portion of the first coupling member and the second coupling member in the state in which an end of the first coupling member and an end of the second coupling member overlap each other in a radial direction, and one or more sealing members provided on coupling surfaces of at least two of the first coupling member, the second coupling member, and the third coupling member.

In the present invention, the first coupling member may be provided with a fitting projecting portion fitted into a space defined between the heat conduction path formation means and the connection pipe of the male connector, and each of the first coupling member and the second coupling member may be step-coupled to an end of the connection pipe.

In the present invention, the sealing members may include a first sealing member provided between the coupling surfaces of the first coupling member and the third coupling member and a second sealing member provided between the coupling surfaces of the first coupling member, the second coupling member, and the third coupling member.

In the present invention, the second sealing member may be provided between an outer of the first coupling member, an end of the second coupling member, and a lower surface of the third coupling member, and the second sealing member may be formed with a sectional shape of a “cross” or an “X” or may be formed in the shape of a ring having a recess formed in an outer surface thereof.

In the present invention, a wedge-shaped protrusion may be formed on each of the coupling surfaces of the first coupling member and the second coupling member between which the second sealing member is provided, and the wedge-shaped protrusion may be formed so as to correspond to the recess formed in the outer surface of the second sealing member.

In the present invention, the heat conduction path formation means may include a first heat conduction path member provided in the male connector, the first heat conduction path member being configured to form a zigzag heat conduction path, and a second heat conduction path member provided in the female connector, the second heat conduction path member being configured to form a zigzag heat conduction path, and each of the first heat conduction path member and the second heat conduction path member may be formed as a tubular body whose cross section is formed in one of a “ [symbol] ” shape, a “⊏” shape, and a “ [symbol] ” shape.

In the present invention, one of the first heat conduction path member and the second heat conduction path member may extend toward the other of the first heat conduction path member and the second heat conduction path member so as to be in partial contact with the other of the first heat conduction path member and the second heat conduction path member.

In the present invention, the quick connector may further include a third sealing member provided between the contact surfaces of the first heat conduction path member and the second heat conduction path member, wherein the third sealing member may block connection between spaces separated into the upper and lower sides based on the contact surfaces of the first heat conduction path member and the second heat conduction path member such that the spaces are separated from each other.

The quick connector for ultra-low temperature vacuum pipes according to the present invention has the following effects.

First, the quick connector for ultra-low temperature vacuum pipes according to the present invention has effects in that the size of an apparatus to which the quick connector is applied can be minimized by shortening the length of the quick connector and the quick connector can be used universally in various high-density apparatuses since a sufficient heat conduction path can be secured.

Second, the quick connector for ultra-low temperature vacuum pipes according to the present invention has effects in that the fluid sealing capability can be maintained even when the quick connector is used horizontally, perfect sealing capability can be retained even in environments using high-pressure fluids, and elastic setting design considering low-temperature contraction is possible, thereby ensuring airtightness even at extremely low temperatures and reliably preventing freezing and condensation at the connection portion of the quick connector.

Third, the quick connector for ultra-low temperature vacuum pipes according to the present invention has effects in that a fluid transfer pipe does not come into direct contact with the outer casing and freezing and condensation on the casing are prevented through the formation of multiple pockets.

Fourth, the quick connector for ultra-low temperature vacuum pipes according to the present invention has effects in that vacuum in the connector is permanently maintained, occurrence of cracks caused by low-temperature/room temperature contraction and expansion is permanently prevented, and high vacuum formation is achieved, thereby maximizing insulation effects.

Fifth, the quick connector for ultra-low temperature vacuum pipes according to the present invention has effects n that the quick connector can be used independently without the need for low-temperature-specific pipes, thereby improving cost-effectiveness and enhancing versatility.

Sixth, the quick connector for ultra-low temperature vacuum pipes according to the present invention has effects in that sealing performance can be secured regardless of the type of coolant, excellent insulation can be achieved regardless of the vaporization rate of a medium used in the quick connector, and insulation can be further maximized by suppressing internal convection through separation of the inner and outer spaces in the quick connector, thereby improving the reliability of the apparatus.

The effects of the present invention are not limited to those mentioned above, and other unmentioned effects will be clearly understood by those skilled in the art based on the following description.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing a conventional quick connector, wherein both a perspective view and a sectional view are provided to facilitate understanding of the configuration;

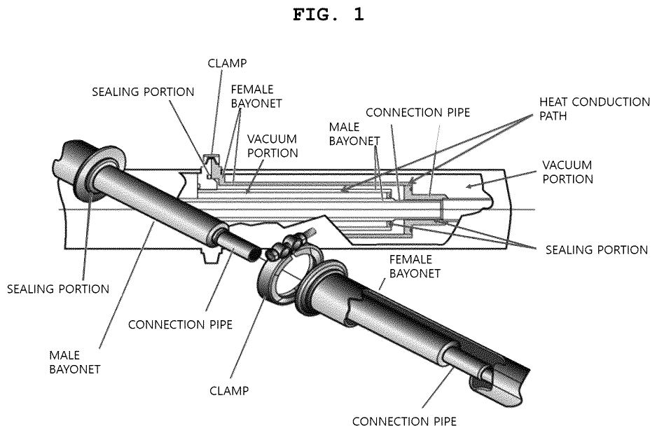

FIG. 2 is a perspective view showing a quick connector for ultra-low temperature vacuum pipes according to the present invention;

FIG. 3 is a sectional view showing a part (upper half) of the quick connector for ultra-low temperature vacuum pipes according to the present invention;

FIG. 4 is a sectional view showing a male connector and a female connector included in the quick connector for ultra-low temperature vacuum pipes according to the present invention in the state in which the male connector and the female connector are separated from each other;

FIG. 5 is an enlarged view of part “A” of FIG. 3, showing a connection portion between the male connector and the female connector of the quick connector for ultra-low temperature vacuum pipes according to the present invention;

FIG. 6 is a separated enlarged view of part “A” of FIG. 3;

FIG. 7 is a view illustrating a space layer separation portion in the quick connector for ultra-low temperature vacuum pipes according to the present invention;

FIG. 8 is a view illustrating a permanent vacuum formation portion of the quick connector for ultra-low temperature vacuum pipes according to the present invention;

FIG. 9 is a view showing an implementation(s) of a heat transfer reduction means included in the quick connector for ultra-low temperature vacuum pipes according to the present invention; and

FIG. 10 is an experimental photograph showing temperature measurements at a plurality of positions on a manufactured product of the quick connector for ultra-low temperature vacuum pipes according to the present invention.

### DETAILED DESCRIPTION OF THE INVENTION

The additional objects, features, and advantages of the present invention will be more clearly understood from the following detailed description and the accompanying drawings.

Prior to the detailed description of the present invention, the present invention may be variously changed and may have various embodiments. The examples described below and shown in the drawings are not intended to limit the present invention to specific embodiments, and it should be understood that the present invention includes all modifications, equivalents, and substitutions included in the idea and technical scope of the present invention.

It should be understood that, when a component is referred to as being “connected to” or “coupled to” another component, it may be directly connected to or coupled to the other component or intervening components may be present. In contrast, it should be understood that, when a component is referred to as being “directly connected to” or “directly coupled to” another component, there are no intervening components present.

The terms used in the present invention are used only to describe a specific embodiment, not to define the present invention. Singular forms include plural forms unless mentioned otherwise. It should be understood that the terms “comprises”, “has”, etc. specify the presence of stated features, numbers, steps, operations, components, parts, or combinations thereof described in this specification, but do not preclude the presence or addition of one or more other features, numbers, steps, operations, components, parts, or combinations thereof.

In addition, the term “part”, “unit”, or “module” stated in the specification means an element configured to perform at least one function or operation, which may be implemented by hardware, software, or a combination of hardware and software.

Furthermore, in describing the present invention with reference to the accompanying drawings, the same components will be denoted by the same reference numerals regardless of the drawing symbols, and duplicate descriptions thereof will be omitted. In describing the present invention, a detailed description of related known technology will be omitted when the same may obscure the subject matter of the present invention.

Hereinafter, a quick connector for ultra-low temperature vacuum pipes according to a preferred embodiment of the present invention will be described in detail with reference to the accompanying drawings.

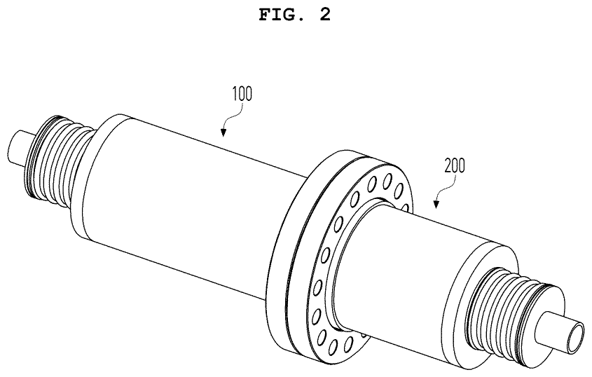

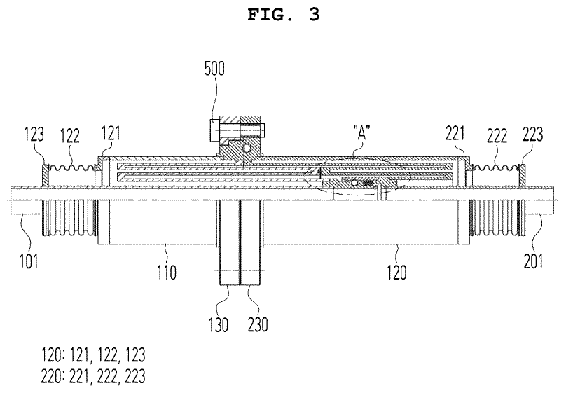

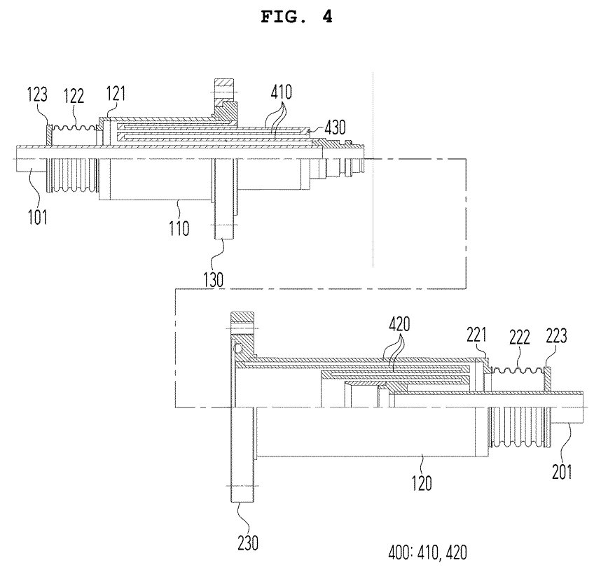

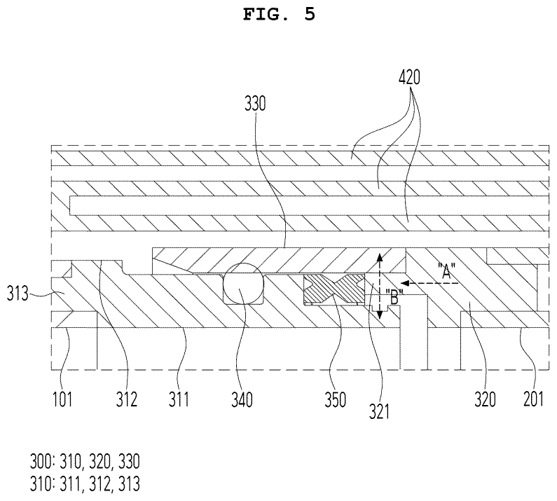

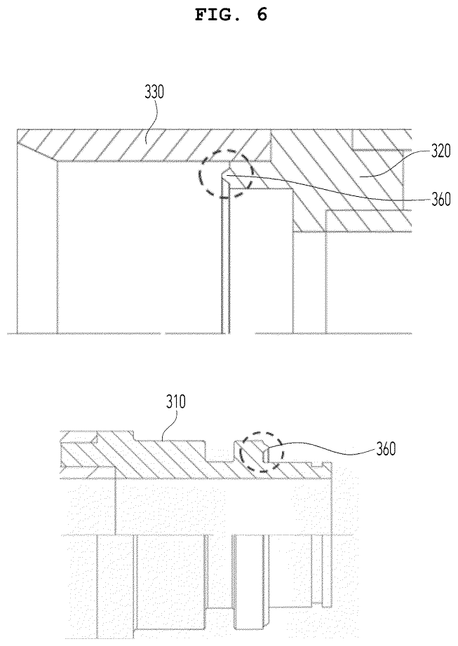

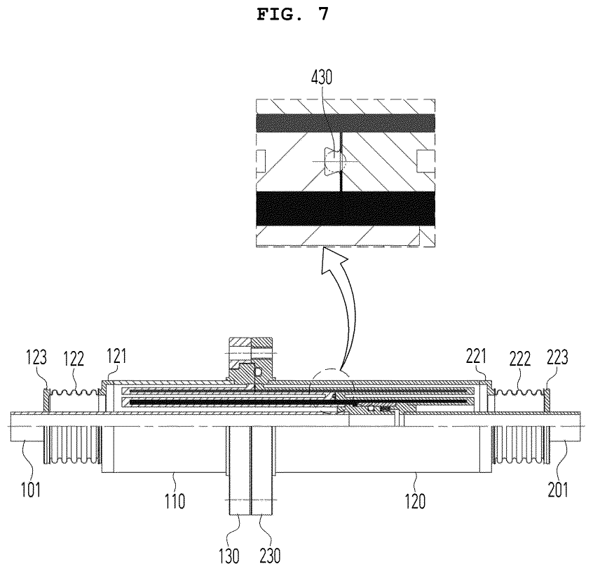

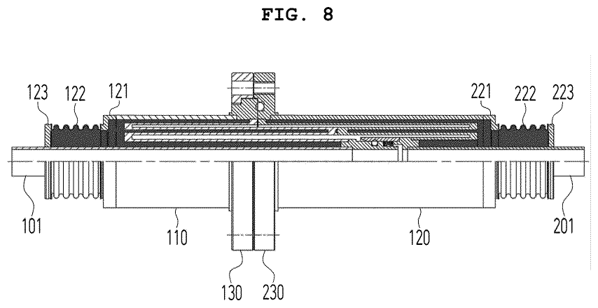

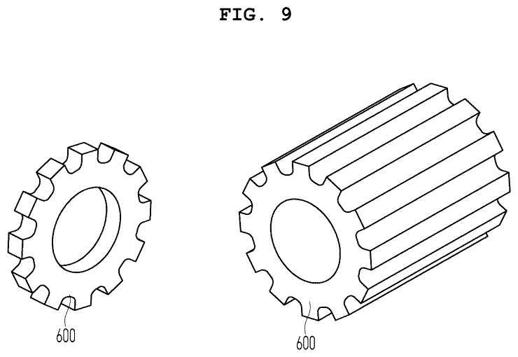

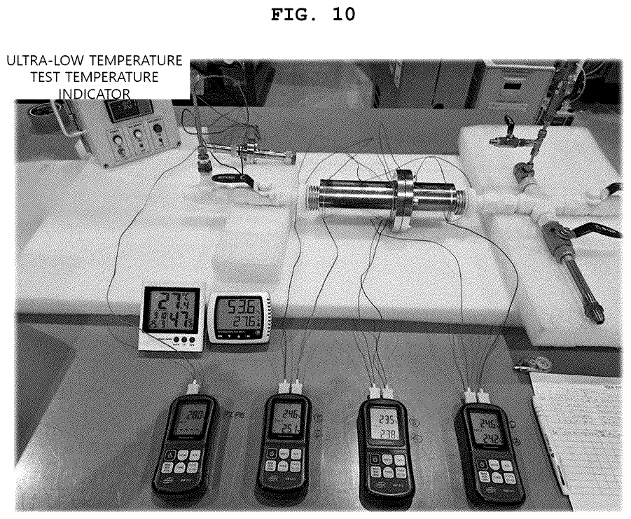

FIG. 2 is a perspective view showing a quick connector for ultra-low temperature vacuum pipes according to the present invention, FIG. 3 is a sectional view showing a part (upper half) of the quick connector for ultra-low temperature vacuum pipes according to the present invention, and FIG. 4 is a sectional view showing a male connector and a female connector included in the quick connector for ultra-low temperature vacuum pipes according to the present invention in the state in which the male connector and the female connector are separated from each other. FIG. 5 is an enlarged view of part “A” of FIG. 3, showing a connection portion between the male connector and the female connector of the quick connector for ultra-low temperature vacuum pipes according to the present invention, and FIG. 6 is a separated enlarged view of part “A” of FIG. 3. FIG. 7 is a view illustrating a space layer separation portion in the quick connector for ultra-low temperature vacuum pipes according to the present invention, FIG. 8 is a view illustrating a permanent vacuum formation portion of the quick connector for ultra-low temperature vacuum pipes according to the present invention, FIG. 9 is a view showing an implementation(s) of a heat transfer reduction means included in the quick connector for ultra-low temperature vacuum pipes according to the present invention, and FIG. 10 is an experimental photograph showing temperature measurements at a plurality of position on a manufactured product of the quick connector for ultra-low temperature vacuum pipes according to the present invention.

As shown in FIGS. 2 to 10, the quick connector for ultra-low temperature vacuum pipes according to the present invention broadly includes a male connector 100, a female connector 200, a pipe connection means 300, a heat conduction path formation means 400, and a clamp means 500.

Specifically, as shown in FIGS. 2 to 10, the quick connector for ultra-low temperature vacuum pipes according to the present invention includes a male connector 100 having a connection pipe (a male connection pipe) 101 provided on a longitudinal center axis, a female connector 200 having a connection pipe (a female connection pipe) 201 provided on the longitudinal center axis, the female connector 200 being connected to the male connector 100 via a coupling means (a pipe coupling means) 300, a coupling means (a pipe coupling means) 300 configured to couple the connection pipe 101 of the male connector 100 and the connection pipe 102 of the female connector 200 to each other, a heat conduction path formation means 400 provided in each of the male connector 100 and the female connector 200, the heat conduction path formation means 400 being configured to form a multilayer heat conduction path in a radial direction (a direction perpendicular to the connection pipe), and a clamp means 500 configured to fasten and couple the male connector 100 and the female connector 200 to each other. In addition, the quick connector for ultra-low temperature vacuum pipes according to the present invention may further include at least one heat transfer reduction means 600 provided on the axis of the connection pipe 101 of the male connector 100 and the axis of the connection pipe 201 of the female connector 200, the heat transfer reduction means 600 being configured to reduce heat transfer in each of the male connector 100 and the female connector 200.

The male connector 100 is a component configured such that the connection pipe (the male connection pipe) 101 provided on the longitudinal center axis of the male connector 100 is coupled to the female connection pipe 201 of the female connector 200 via the pipe coupling means 300, the male connector 100 is fastened and coupled to the female connector 200 via the clamp means 500, and the heat conduction path formation means 400, a description of which will follow, is included in the male connector 100.

Specifically, the male connector 100 includes a cylindrical casing 110, a coupling cover member 120 provided at one end of the casing 110 (an end oriented in a direction opposite a direction in which the male connector 100 is coupled to the female connector or a left end in the FIGS.), a fastening flange 130 provided at the other end of the casing 110, the fastening flange 130 having an outer diameter greater than the diameter of the casing 110, and a connection pipe 101 provided on the longitudinal center axis of the casing 110, both ends of the connection pipe 101 being exposed outside the casing 110.

The coupling cover member 120 includes a flange portion 121 having one end coupled (vacuum brazed) to the casing 110, a bellows portion 122 having one end coupled (vacuum brazed) to the other end of the flange portion 121, and a closing cap portion 123 coupled to the other end of the bellows portion 122, the closing cap portion 123 having a pipe through-hole formed in the center thereof.

The bellows portion 122 formed as a thin metal body.

In the present invention, since the coupling cover member 120 is provided with a thin bellows portion 122, a heat conduction path is long and thin in the place where the coupling cover member 120 comes into direct contact with a low-temperature fluid pipe and in a narrow space, thereby minimizing heat transfer and minimizing a cladding freezing section.

In addition, in the present invention, the coupling cover member 120 forms an ultra-high vacuum in the internal space using vacuum brazing at the time of bonding, thereby preventing heat conduction due to convection inside and eliminating a vacuum port on the outside. In other words, the bellows portion 122 is used at the connection region between the outside and inside of the connector (i.e., the assembly region, not the fastening region), thereby minimizing heat conduction.

In the present invention, the male connector 100 and the female connector 200 are manufactured using a vacuum brazing method, thereby securing a permanent vacuum state and minimizing heat transfer due to convection. In other words, in the present invention, the male connector 100 and the female connector 200 are manufactured by vacuum brazing, thereby ensuring that the vacuum in the connector is permanently maintained, preventing cracks caused by expansion and contraction at low and room temperatures, and achieving extremely high vacuum formation to maximize insulation effects (see FIG. 8). The part marked in color in FIG. 8 indicates a permanent vacuum formation portion of the quick connector, which is symmetrically formed below although not shown.

The female connector 200 is a component configured such that the connection pipe 201, which is hermetically coupled to the connection pipe 101 of the male connector 100 via the pipe coupling means 300, is provided on the longitudinal center axis, the female connector 200 is coupled to one end of the male connector 100 via the clamp means 600, and the heat conduction path formation means 400, a description of which will follow, is included in the female connector 200.

Specifically, the female connector 200 includes a cylindrical casing 210, a coupling cover member 220 provided at the other end of the casing 210 (an end oriented in a direction opposite a direction in which the female connector 200 is coupled to the male connector or a right end in the figures), a fastening flange 230 provided at one end of the casing 210, the fastening flange 230 having an outer diameter greater than the diameter of the casing 210, and a connection pipe 201 provided on the longitudinal center axis of the casing 210, the other end of the connection pipe 201 being exposed outside the casing 210.

The female connector 200 also includes a coupling cover member 220, which is identical to the coupling cover member 220 of the male connector 200.

Specifically, the coupling cover member 220 includes a flange portion 221 having one end coupled (vacuum brazed) to the casing 210, a bellows portion 222 having one end coupled (vacuum brazed) to the other end of the flange portion 221, and a closing cap portion 223 coupled to the other end of the bellows portion 222, the closing cap portion 223 having a pipe through-hole formed in the center thereof.

The pipe coupling means 300 is a component that is provided at the other end of the connection pipe 101 of the male connector 100 and at one end of the connection pipe 201 of the female connector 200 and is configured to hermetically couple the two connection pipes 101 and 201 to each other.

The pipe coupling means 300 includes a first coupling member 310 provided at the other end of the connection pipe 101 of the male connector 100, a second coupling member 320 provided at one end of the connection pipe 201 of the female connector 200, a third coupling member 330 coupled to the outside of an overlapping portion of the first coupling member 310 and the second coupling member 320 in the state in which an end of the first coupling member 310 and an end of the second coupling member 320 overlap each other, and one or more sealing members 340 and 350 provided on coupling surfaces of the first coupling member 310, the second coupling member 320, and the third coupling member 330.

The first coupling member 310 may be formed in a cylindrical shape, and a plurality of stepped portions may be provided outside the first coupling member 310.

Specifically, the first coupling member 310 includes a cylindrical body portion 311 and a flange portion 312 formed at one end of the body portion 311, the flange portion 312 extending outward.

An outer surface of the body portion 311 is preferably formed with a stepped portion having two or more stages. In other words, the body portion 311 is formed with a stepped portion having stages gradually reduced from the flange portion 312 toward the other end thereof.

The first coupling member 310 has a mounting portion formed on an outer surface thereof facing the outside in the radial direction, the mounting portion including a mounting recess in which the sealing members 340 and 350 are seated. As will be described below, the mounting portion is provided with a wedge-shaped protrusion configured to strongly come into tight contact with the sealing members 340 and 350 so as to correspond to the shape of the sealing members 340 and 350, which will be described in detail below.

In addition, a fitting projecting portion 313 fitted into a space defined between the heat conduction path formation means 400 and the male connection pipe 101 is formed on a rear surface (a surface oriented in a direction opposite a direction toward the female connector) of the flange portion 312 of the first coupling member 310.

The second coupling member 320 is mounted on the end of the connection pipe 201 of the female connector 200. One end of the second coupling member 320 has an extension portion 321 extending toward the male connector 100, wherein the extension portion 321 is formed as a tubular body provided at one end (a small-diameter end) of the first coupling member 310 so as to overlap the first coupling member 310 in the radial direction.

In the present invention, a lower surface of one end of the second coupling member 320 is step-coupled to the end of the female connection pipe 201, and an upper surface of one end of the second coupling member 320 is step-coupled to the end of the heat conduction path formation means 400, a description of which will follow.

The third coupling member 330 is formed as a tubular body mounted on the outside of the overlapping portion of the first coupling member 310 and the second coupling member 320 in the state in which the end of the first coupling member 310 and the end of the second coupling member 320 overlap each other.

The sealing members 340 and 350 are components provided on the coupling surfaces of the first coupling member 310, the second coupling member 320, and the third coupling member 330.

In the present invention, the sealing members 340 and 350 include a first sealing member 340 configured to seal the coupling surfaces of the first coupling member 310 and the third coupling member 330 and a second sealing member 350 configured to seal the coupling surfaces of the first coupling member 310, the second coupling member 320, and the third coupling member 330.

The first sealing member 340 is provided in the mounting recess of the mounting portion formed on the outer surface of the first coupling member 310 in the radial direction, and is made of a material that is elastic and durable.

The second sealing member 350 is provided between an outer surface of the first coupling member 310 in the radial direction, an end of the extension portion 321 of the second coupling member 320, and a lower surface of the third coupling member 330, and is made of a material that is elastic and durable.

In the present invention, the second sealing member 350 is preferably formed with a sectional shape of a “cross” or an “X” or is preferably formed in the shape of a ring having a recess formed in an outer surface thereof, as shown in FIGS. 6 and 7.

In this case, a wedge-shaped protrusion 360 is formed on each of the coupling surfaces of the first coupling member 310 and the second coupling member 320 between which the second sealing member 350 is interposed, as shown in FIG. 7, wherein the wedge-shaped protrusion 360 is formed so as to correspond to the recess formed in the outer surface of the second sealing member 350, and the wedge-shaped protrusion 360 is fitted into recess of the second sealing member 350 formed in an “X” shape, which is interposed between the coupling surfaces of the first coupling member 310 and the second coupling member 320.

When pressure is applied to the second sealing member 350 and the wedge-shaped protrusion 360 in direction “A” by a flowing fluid, as shown in FIG. 6, the second sealing member 350 is compressed in direction “A” and simultaneously pressed in direction “B”, whereby the second sealing member 350 and the wedge-shaped protrusion 360 are strongly brought into tight contact with each other in both directions “A” and “B”, which further ensures reliable sealing performance.

In other words, the quick connector for ultra-low temperature vacuum pipes according to the present invention having the above-described sealing structure has perfect sealing capability even in an environment in which a high-pressure fluid is used, and maintains the fluid sealing capability even when the apparatus is used horizontally.

The wedge-shaped protrusion 360 may also be formed on a lower surface of the third coupling member 330.

The heat conduction path formation means 400 is a component that is provided in each of the male connector 100 and the female connector 200 and forms a multilayer heat conduction path in the radial direction (the direction perpendicular to the connection pipe).

Specifically, the heat conduction path formation means 400 includes a male connector heat conduction path member (or a first heat conduction path member) 410 configured to form a zigzag heat conduction path in a space defined between the outside of the connection pipe 101 of the male connector 100 and the inside of the casing 110 and a female connector heat conduction path member (or a second heat conduction path member) 420 configured to form a zigzag heat conduction path in a space defined between the outside of the connection pipe 201 of the female connector 200 and the inside of the casing 210.

In the present invention, each of the first heat conduction path member 410 and the second heat conduction path member 420 is formed as a tubular body whose cross section is formed in one of a “ [symbol] ” shape, a “⊏” shape, and a “ [symbol] ” shape.

Each of the first heat conduction path member 410 and the second heat conduction path member 420 configured as described above has slight elasticity, which prevents detachment of the first heat conduction path member 410 and the second heat conduction path member 420 from the sealing portion even when low-temperature shrinkage occurs.

In other words, the quick connector for ultra-low temperature vacuum pipes according to the present invention allows for an elastic design that accounts for contraction, thereby ensuring sealing performance under extreme low-temperature conditions (various low-temperature contraction environments).

In addition, in the present invention, one of the first heat conduction path members 410 and the second heat conduction path members 420 is formed with a predetermined length projecting outward from the casing 110 or 120, and the other of the first heat conduction path member 410 and the second heat conduction path member 420 is formed in the casing 110 or 120 with a length reduced by the projecting length.

The figures show the case in which the first heat conduction path member 410 provided in the male connector 100 protrudes outside the casing 110 and the second heat conduction path member 420 provided in the female connector 200 is located in the casing 210.

In the present invention, since each of the first heat conduction path member 410 and the second heat conduction path member 420 is formed in the above-described sectional shape, when the male connector 110 and the female connector 200 are coupled to each other, as shown in FIG. 7, a convection space is partitioned (separated) in each of the male connector 100 and the female connector 200, and the space of the heat conduction path member 410 or 420 and the internal space of the casing 110 or 210 communicate with each other.

Here, based on contact surfaces of the first heat conduction path member 410 and the second heat conduction path member 420, each of upper and lower sides thereof form a closed space, and the upper and lower closed spaces communicate with each other through a micro gap between the contact surfaces. The quick connector for ultra-low temperature vacuum pipes according to the present invention further includes a third sealing member 430 provided between the contact surfaces of the first heat conduction path member 410 and the second heat conduction path member 420.

In the present invention, therefore, since the third sealing member 430 is further provided between the contact surfaces of the first heat conduction path member 410 and the second heat conduction path member 420, the space layers are separated from each other, thereby preventing a decrease in the heat conduction effects due to internal convection and external convection and thus maximizing the heat insulation effect through blocking of the intermediate space.

That is, the third sealing member provided between the contact surfaces of the first heat conduction path member and the second heat conduction path member blocks connection between the spaces separated into the upper and lower sides based on the contact surfaces of the first heat conduction path member and the second heat conduction path member, thereby maximizing the heat insulation effect.

The clamp means 500 is a component configured to fasten and couple the male connector 100 and the female connector 200 to each other. The configuration of the clamp means 500 is not limited to the configuration shown in the figures, and any known configuration may be adopted as long as it is possible to fasten and couple the male connector 100 and the female connector 200 to each other.

Meanwhile, the quick connector for ultra-low temperature vacuum pipes according to the present invention may further include at least one heat transfer reduction means 600 provided on the axis of the connection pipe 101 of the male connector 100 and the axis of the connection pipe 201 of the female connector 200, the heat transfer reduction means 600 being configured to reduce heat transfer in each of the male connector 100 and the female connector 200.

The heat transfer reduction means 600 is fixed to the outer surface of each of the connection pipes 101 and 201, as shown in FIG. 10, and is formed as a ring-shaped member (or a cryo-trap member) made of a metallic material having excellent thermal conductivity.

The heat transfer reduction means 500 formed as a ring-shaped member is provided at both ends of each of the connection pipes 101 and 201 and at the position at which the connection pipes 101 and 201 are fastened to each other via the clamp means 500, and it is preferable for the heat transfer reduction means 500 to be machined so as to have a rough surface.

The heat transfer reduction means 600 captures moisture and molecules below the dew point temperature in the space of the connector, forming a weak vacuum. The resulting vacuum reduces convective heat transfer, thereby improving insulation performance.

Meanwhile, the inventor of the present invention has manufactured the quick connector for ultra-low temperature vacuum pipes according to the present invention, has measured the temperature at a plurality of positions while passing an ultra-low temperature fluid, and has confirmed that the temperature was measured within an error range, as shown in FIG. 10.

As is apparent from the above description, the quick connector for ultra-low temperature vacuum pipes according to the present invention has advantages in that the size of an apparatus to which the quick connector is applied can be minimized by shortening the length of the quick connector, the quick connector can be used universally in various high-density apparatuses since a sufficient heat conduction path can be secured, the fluid sealing capability can be maintained even when the quick connector is used horizontally, perfect sealing capability can be retained even in environments using high-pressure fluids, and elastic setting design considering low-temperature contraction is possible, thereby ensuring airtightness even at extremely low temperatures and reliably preventing freezing and condensation at the connection portion of the quick connector.

In addition, the quick connector for ultra-low temperature vacuum pipes according to the present invention has advantages in that a fluid transfer pipe does not come into direct contact with the outer casing, freezing and condensation on the casing are prevented through the formation of multiple pockets, vacuum in the connector is permanently maintained, occurrence of cracks caused by low-temperature/room temperature contraction and expansion is permanently prevented, and high vacuum formation is achieved, thereby maximizing insulation effects.

In addition, the quick connector for ultra-low temperature vacuum pipes according to the present invention has advantages in that the quick connector can be used independently without the need for low-temperature-specific pipes, thereby improving cost-effectiveness and enhancing versatility, sealing performance can be secured regardless of the type of coolant, excellent insulation can be achieved regardless of the vaporization rate of a medium used in the quick connector, and insulation can be further maximized by suppressing internal convection through separation of the inner and outer spaces in the quick connector, thereby improving the reliability of the apparatus.

The embodiments described in this specification and the accompanying drawings merely describe some of the technical ideas included in the present invention by way of example. Consequently, the embodiments disclosed in this specification are not provided to limit the technical ideas of the present invention but to describe the technical ideas of the present invention, and therefore the scope of the technical ideas of the present invention is not limited by the embodiments. It be interpreted should that all modifications and concrete embodiments that can be easily inferred by those skilled in the art within the scope of the technical ideas of the present invention included in the specification and the drawings of the present invention are included in the scope of rights of the present invention.

What is claimed is:

1. A quick connector for ultra-low temperature vacuum pipes, the quick connector comprising:
a male connector having a connection pipe provided along a center line thereof;
a female connector having a connection pipe provided along a center line thereof, the female connector being connected to the male connector;
a pipe coupling means configured to couple the connection pipe of the male connector and the connection pipe of the female connector to each other; and
a heat conduction path formation means provided in each of the male connector and the female connector, the heat conduction path formation means being configured to form a multilayer heat conduction path in a direction perpendicular to the connection pipe, a part of the heat conduction path formation means provided in the male connector and a part of the heat conduction path formation means provided in the female connector being in contact with each other.

2. The quick connector according to claim 1, wherein
each of the male connector and female connector comprises a casing, a coupling cover member provided at one end of the casing, and a fastening flange provided at the other end of the casing, and
the coupling cover member comprises a flange portion having one end coupled to the casing, a bellows portion having one end coupled to the other end of the flange portion, and a closing cap portion coupled to the other end of the bellows portion, the closing cap portion having a pipe through-hole formed in a center thereof, and
the coupling cover member and the connection pipe are vacuum brazed.

3. The quick connector according to claim 1, wherein the pipe coupling means comprises:
a first coupling member provided at the other end of the connection pipe of the male connector;
a second coupling member provided at one end of the connection pipe of the female connector;
a third coupling member coupled to an outside of an overlapping portion of the first coupling member and the second coupling member in a state in which an end of the first coupling member and an end of the second coupling member overlap each other in a radial direction; and
one or more sealing members provided on coupling surfaces of at least two of the first coupling member, the second coupling member, and the third coupling member.

4. The quick connector according to claim 1, wherein
the first coupling member is provided with a fitting projecting portion fitted into a space defined between the heat conduction path formation means and the connection pipe of the male connector, and
each of the first coupling member and the second coupling member is step-coupled to an end of the connection pipe.

5. The quick connector according to claim 3, wherein the sealing members comprise:
a first sealing member provided between the coupling surfaces of the first coupling member and the third coupling member; and
a second sealing member provided between the coupling surfaces of the first coupling member, the second coupling member, and the third coupling member.

6. The quick connector according to claim 5, wherein
the second sealing member is provided between an outer surface of the first coupling member, an end of the second coupling member, and a lower surface of the third coupling member, and
the second sealing member is formed with a sectional shape of a “cross” or an “X” or is formed in a shape of a ring having a recess formed in an outer surface thereof.

7. The quick connector according to claim 6, wherein
a wedge-shaped protrusion is formed on each of the coupling surfaces of the first coupling member and the second coupling member between which the second sealing member is provided, and
the wedge-shaped protrusion is formed so as to correspond to the recess formed in the outer surface of the second sealing member.

8. The quick connector according to claim 1, wherein
the heat conduction path formation means comprises a first heat conduction path member provided in the male connector, the first heat conduction path member being configured to form a zigzag heat conduction path, and a second heat conduction path member provided in the female connector, the second heat conduction path member being configured to form a zigzag heat conduction path, and
each of the first heat conduction path member and the second heat conduction path member is formed as a tubular body whose cross section is formed in one of a “ [symbol] ” shape, a “⊏” shape, and a “ [symbol] ” shape.

9. The quick connector according to claim 1, wherein one of the first heat conduction path member and the second heat conduction path member extends toward the other of the first heat conduction path member and the second heat conduction path member so as to be in partial contact with the other of the first heat conduction path member and the second heat conduction path member.

10. The quick connector according to claim 9, further comprising:
a third sealing member provided between the contact surfaces of the first heat conduction path member and the second heat conduction path member, wherein
the third sealing member blocks connection between spaces separated into the upper and lower sides based on the contact surfaces of the first heat conduction path member and the second heat conduction path member such that the spaces are separated from each other.
